(19) United States
(12) Patent Application Publication
(10) Pub. No.: US 2026/0272746 A1
(43) Pub. Date: Sep. 17, 2026

(54) Pressure Injury Relief System

(71) Applicants: Ashish Purekar, Rockville, MD (US); Pablo Sztein, Silver Spring, MD (US); Gregory Hiemenz, Silver Spring, MD (US); Amit N. Shah, North Potomac, MD (US)

(72) Inventors: Ashish Purekar, Rockville, MD (US); Pablo Sztein, Silver Spring, MD (US); Gregory Hiemenz, Silver Spring, MD (US); Amit N. Shah, North Potomac, MD (US)

(21) Appl. No.: 19/680,413

(22) Filed: May 18, 2026

Related U.S. Application Data
(63) Continuation-in-part of application No. 17/875,511, filed on Jul. 28, 2022.

(51) Int. Cl. A61G 7/057

(52) U.S. Cl. CPC A61G 7/05784; A61G 7/05715

(57) ABSTRACT

The present invention relates to a system to reduce pressure-induced skin and soft tissue injury to patients, and more particularly to a system of lightweight, packable support pad or pads to alleviate contact pressure, friction, temperature, and moisture.

### CROSS-REFERENCE TO RELATED APPLICATION

The present application is a continuation-in-part of application Ser. No. 17/875,511 filed 2022-07-28, which in turn derived priority from U.S. provisional application Ser. No. 63/227,061 filed on 29 Jul. 2021.

### BACKGROUND OF THE INVENTION

### Field of the invention

The present invention relates to a system to reduce pressure-induced skin and soft tissue injury.

### Description of the Background

While the treatment and stabilization of medical conditions are the primary objectives of caregivers, the prevention of secondary injury is also important for optimizing overall outcomes and recovery time. For immobile and immobilized patients, secondary injuries such as pressure-induced skin and soft tissue injury (PSSTI) can start to form soon after injury and progress as the patient moves through the chain of care. These injuries may go unnoticed, and even be exacerbated, during care delivered in medical treatment facilities where resources and capabilities are sparse compared to higher level-of-care facilities. Ultimately, PSSTI can complicate medical treatment and tax scant resources.

PSSTI arises due to extended duration of pressure (contact force and friction) and prolonged exposure to wetness. Areas primarily affected include the back of the head, shoulders, elbows, lower back/sacrum, and heels. In Operation Iraqi Freedom, 38% of admissions to the polytrauma rehabilitation center had pressure-related injuries. In these instances, occipital lesions (i.e., back of the head) were approximately half of the stage II or greater pressure injuries. Similar rates were found for casualties returning from Afghanistan. In hospital settings, an automated approach to PSSTI minimization uses air mattresses or mattress overlays with discrete cells that inflate/deflate to redistribute pressure.

Devices developed to reduce the incidence of PSSTI fall into two categories passive support surfaces and active support surfaces. Passive support surfaces impart low contact pressure to patients and include conformable foam mattresses and mattresses with alternate fill materials such as air, water, gel, fiber, or beads. Active support surfaces include mattresses that provide alternating pressure, air fluidized beds, and low air loss beds. There is currently insufficient data to establish the superiority of one PSSTI reduction approach over another.

While an active support surface has shown effectiveness in reducing PSSTI, a lack of mechanical reliability of the pump used to periodically redistribute air in the cells has been identified as a key failure point. Moreover, the noise produced by the pump interferes with recuperation. Active systems are unsuitable in military and certain pre-hospital settings due to their size, weight, power requirement, cost, and noise during use.

Passive support surfaces may provide a superior combination of PSSTI reduction effectiveness, size, simplicity, and weight compared to active methods.

The cushioning system can provide additional benefits to manage hypothermia related risks in patient care. Heat loss impacts cardiac function and rhythm, blood coagulation, metabolic activity, and immune response which can impact patient care in austere environments.

### SUMMARY OF THE INVENTION

The present invention is a support cushioning system to reduce PSSTI using a system of aligned or positioned support pads capable of reducing contact pressure, friction, and heat in areas prone to PSSTI.

The support cushions are constructed of one or more layers of a soft, compressible material such as polyurethane or silicone foam. The density and stiffness properties of each support cushion is tailored to the region of the body that is supported through selection and arrangement of the one or more layers of compressible material.

The support cushions are encapsulated by a cover to protect the pads inside from being soaked by fluids including water, blood, and chemicals.

The cover material comprises fabric that is biocompatible, antimicrobial, waterproof, and weldable to other fabrics or to itself. Weldable fabrics use direct heat, heat produced by application of ultrasonic energy, or heat produced by application of electromagnetic energy including radio frequency methods to bond sections of fabrics together. The cover material properties preferably include stretchability where the fabric can expand in both directions while still maintaining key properties for the cushion.

Cover construction includes seams where sections of fabric are sewn or welded. Such seams are carefully positioned to avoid direct contact with patient skin to help preserve the PSSTI properties of the support cushioning system. The seams are further covered with a fabric tape that reinforces seam strength, further waterproofs the seam, and prevents build-up of foreign matter in the seam that may impact patient care.

The cover also includes one or more vents that allows air transfer across the cover while serving as a barrier to fluid transfer. Each vent prevents air from being trapped inside the pad due to rapid changes in ambient atmospheric pressure such as rapid ascent and descent during emergency aeromedical evacuation. The vent further prevents fluid intrusion into the support system due to rain, washing, spilled liquids, or draining bodily fluids. The support cushioning system may be attached to other patient support or patient movement devices such as a stretcher or litter.

The support cushioning system also includes a fabric flap attached to the cover and used to roll up the cushions while expelling trapped air through the vent assembly to reduce overall size.

Key benefits of the system can be summarized as follows:
Ability to tailor support to areas of the body which are highly susceptible to PSSTI such as the occiput, scapula, and sacrum to reduce contact pressure and friction.
Targeted areas of the body can be completely unloaded by the design of or by simply repositioning support pads.
Ability to improve air flow and enable fluid drainage in order to decrease moisture below the patient.
Ability to improve air flow and reduce skin surface temperature in order to reduce skin and soft tissue injury.
Light weight and a small packed volume allows the cushioning system to be carried and used in austere environments.
Integration with other patient transport and patient movement devices.
Simple and quick deployment-The support surfaces stand ready to rapidly deploy from the stowed configuration to regain their full volumes and accept a patient.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a perspective of a support surface system consisting of distinct regions, 1, 2, 3, 4, with customized density and stiffness foam properties. The pad includes a cut-out region, 5.

FIG. 2 represents the support surface system in FIG. 1 with a support insert 12, inserted into the cut-out region 5 from FIG. 1 to produce a contiguous support surface.

FIG. 3 presents the support surface of FIG. 1 with cover fabric 15, 16 over the foam materials.

FIG. 4 presents a support surface system with a fabric flap 18 used to assist with packing.

FIG. 5 presents a support surface system packed and held in place using the fabric flap 18 from FIG. 4.

FIG. 6 is a perspective view illustrating how cutout 5 reduces sacral pressure.

FIG. 7 shows an embodiment of a vent assembly 13 consisting of exterior component 19, mesh 20, and interior component 21.

FIG. 8 shows a side view of with a welded seam 22 and a position of seam 23.

FIG. 9 shows an alternate embodiment of a vent 33 that is integral to the seam 93 joining cover materials 15, 16.

FIG. 10 shows a side view with a seam covered by seam tape 24.

FIG. 11 shows an alternative embodiment with reconfigurable pads 1-4 attached to a harness system

### DETAILED DESCRIPTION OF THE PREFERRED EMBODIMENTS

The following is a description of a preferred embodiment of a lightweight and packable support surface for patients to reduce the incidence of pressure-induced skin and soft tissue injury and related injuries that may affect care and treatment.

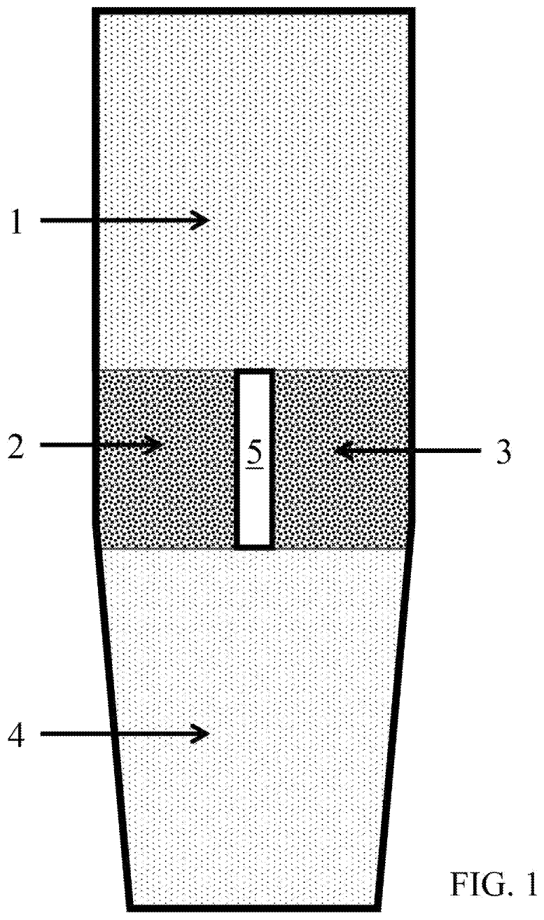

With reference to FIG. 1, an embodiment of the present invention comprises a hexagonal support cushioning system with padding blocks 1, 2, 3, and 4 of variable densities and stiffnesses. Each padding block 1-4 may be formed of open-cell foam material, or a thermoplastic polymer air fiber cushion such as “3D loop”, a specialized cushioning material made from a three-dimensional network of interconnected thermoplastic elastomer loops. Additionally, the pads 1, 2, 3, and 4, can be composed of layers, or stack-up, of variable foam densities and stiffnesses. Candidate densities can range from 1.2-2.1 lbs/ft³. Candidate stiffnesses can range from 10-40 lbs as determined using a standardized Indentation Load Deflection test. Padding materials are able to be compressed down to approximately 16% of original thickness and able regain original thickness. The ability to compress the system is useful in packing the system to reduce occupied volume for stowage or storage. When deployed for use, the rebounding capability of the padding is used to regain original thickness and cushioning support functionality. Padding materials are able to regain, or rebound, to approximately 90% of original thickness after being held in a compressed state.

A cut-out region 5 presents an area where the patient has little to no contact with the support cushioning system.

The overall hexagonal shape is composed of three rectangular pads 1, 2, 3, and one trapezoidal pad 4, the upper and lower pads 1 and 4 being separated by identical side-by-side and smaller rectangular pads 2, 3. formed as above with like thicknesses and foam densities. The overall hexagonal shape conforms to the body, with rectangular support pad 1 designed to support the shoulders and head, and trapezoidal support pad 4 tapering downward to conform to mid-thigh and below. The hexagonal shape of pad 4 also allows the cushioning system to be used with other patient care devices when placed on a litter by providing access to litter poles. An example patient care device is the Special Medical Emergency Evacuation Device which mounts to litter poles. All the support pads 1-4 preferably have a thickness of greater than 2 inches so that they do not get compressed to a point of densification (where the stress-strain relationship for the foam increases dramatically) when supporting a patient. Collapse and densification of the support pads 1-4 results in areas of elevated interface pressure on the patient resulting in increased likelihood of injury. To optimize weight, the support pads 1-4 preferably have a thickness of less than 4 inches. Specifically, support pads 1, 4 designed to support the shoulders, head, mid-thigh, and lower extremities are preferably composed of a thicker section of lower-density foam than support pads 2, 3 designed to support area between the lower torso and mid-thigh. Most preferably support pads 1, 4 are composed of a 3 inch thick section of low-density foam with a density ranging between 1.2-1.8 lbs/ft³. Support pads 2, 3 designed to support area between the lower torso and mid-thigh are preferably composed of a 3 inch thick stackup including a first layer of lower-density foam consisting of 1.2-1.8 lbs/ft³ density foam which is 30-35% of the total thickness and a second layer of foam which is 1.5-2.1 lbs/ft³ density foam for the remaining 65-70% of the thickness (second layer of foam is preferably from 2.33 to 1.86 times thicker than first layer of foam.

Again, these densities, along with the overall thickness of the pads 1-4, reduce the likelihood of pressure related injuries to the patient.

The support cushioning system is expected to be used in aeromedical evacuation of injured patients. Devices used in civilian and military aviation environments must comply with flammability requirements. Compliant foams used in the support cushioning system use chemical additives in the foam fabrication process to result in flame retardant properties.

The support pads 1-4 are preferably designed or arranged to produce areas under the patient with little to no direct contact with the support surfaces. These areas with little or no direct contact with the patient enable increased air flow and reduce moisture and temperature at the patient interface, as well as completely offload areas around bony prominences that are otherwise prone to PSSTI.

One method of producing areas of little or no direct contact of the support surface with the patient is by arranging discrete pads 1-4 such that pads 2, 3 are separated to produce a gap or space between them.

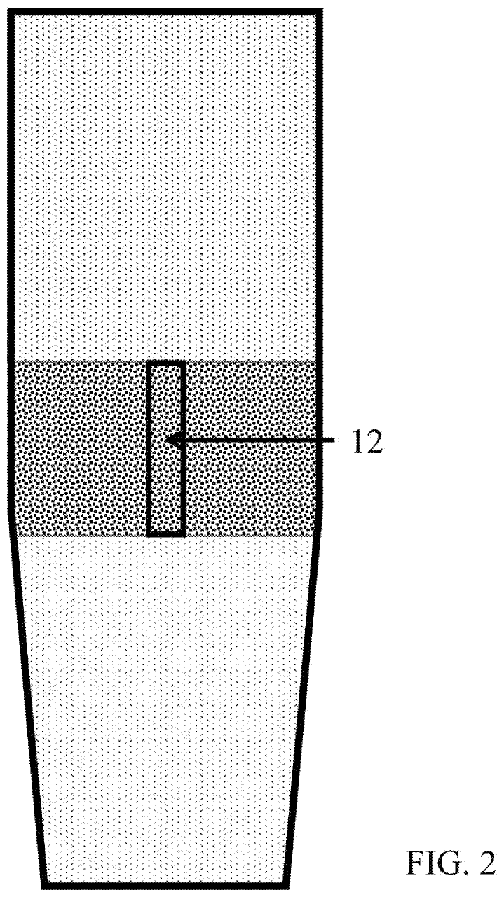

Another method of producing areas of little or no direct contact of the support surface with the patient is using a support surface with removable cut-outs. For example, as seen in FIG. 1, a cut-out region 5 can be used. As seen in FIG. 2 a support cushion insert 12 may be inserted into the cut-out region 5 and thereby used to reconfigure the support cushion system to fill the area 5 with little to no patient contact.

The pads 1-4 are preferably encapsulated by a vented and air-or water-sealed cover to protect the compressible material inside from being soaked by bodily fluids and or water, e.g., if being washed.

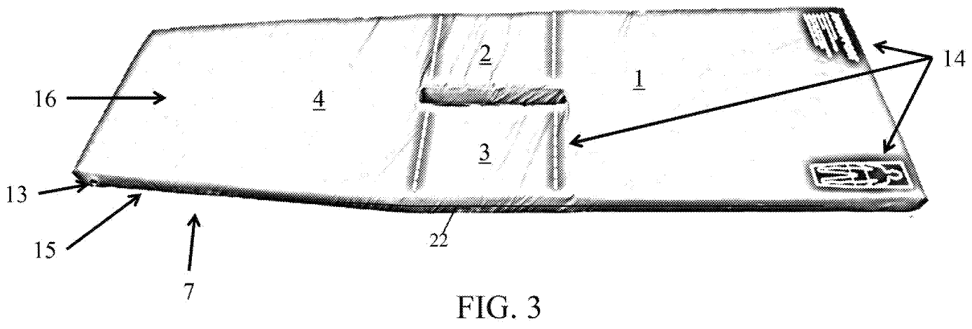

FIG. 3 shows a support cushioning system in which all pads 1-4 are encapsulated within a cover 7 comprising top patient interfacing cover material 16, bottom cover material 15, at least one vent assembly 13, and indicia 14 for proper placement of the patient on the support cushion. The patient interfacing section 16 is preferably welded to the bottom cover material 15 along a sidelong seam 22. The indicia 14 comprises text instructions or illustrations to guide arrangement of the support cushioning system and placement of the patient relative to the cut-outs/gaps. Cover 7 is constructed from either an open weave or open knit fabric which is impregnated or coated using a polymer with additives that, when cured, produces a fabric that may be sewn or welded. Open weave or open knit materials use nylon or polyester yarns to produce a network of interconnected openings. Preferably, a high-tenacity polyester or nylon polyamide yarn provides a suitable high strength base material. Cover 7 is assembled by applying a coating to the base fabric. For example, a film coating may be adhered to the base fabric, or a liquid form of a coating may be applied over the base fabric and cured in place. The coating may be polyurethane or polyvinyl chloride with additive components (described below) to improve functionality. Polyurethane coatings are generally biocompatible with intact and open wounds and reduce incidence of cytotoxicity, irritation, and sensitization. The coating combined with the base fabric provides flexibility and allows the fabric to stretch in orthogonal directions. A coating made from thermoplastic polyurethane or polyvinyl chloride enables heat-based welding to join to other cover fabrics with matching coatings. Alternately, a tie-layer may be used to join cover fabrics with non-matching coatings using heat-based welding. The tie-layer is composed of a film where opposite faces composed of matching material to the cover fabrics intended for joining. Preferably, silver-based, zinc-based, and/or copper-based additives are added to the polyurethane or polyvinyl chloride coating to impart antimicrobial properties to the skin contacting surface of the fabric. Electrically conductive additives, including additives based on carbon, silver, copper, or nickel, can be incorporated into the coating (or integrated into fiber) to produce a fabric that minimizes the build-up of electrical charge that may negatively impact functioning of medical equipment used for patient care. The coating material when applied to produce a uniform contiguous surface prevents movement of air or water through the fabric. The density and composition of the yarns in the base material and thickness of the coating combined provides strength to the cover fabric and imparts tear resistance and abrasion resistance. Surface roughness of the cover material is minimized during fabric construction process to reduce friction with skin. Moreover, the coating material combined with the base fabric material provides flexibility and allows the material fabric to stretch in orthogonal directions. For example, the top cover material 16 is preferably constructed from a layer of fabric material(s) to reduce PSSTI by the ability to stretch in two directions; minimize friction with the patient's skin; reduce incidence of infection using antimicrobial or similar materials; reduce skin irritation using biocompatible materials; and preferably electrically conductive to prevent interference with other medical devices. The bottom cover material 15 is preferably constructed of layer of fabric material(s) that provide ruggedness to abrasion, cutting, and puncture; and prevent water penetration. Cover materials that can stretch on the order of 100-200% in both directions (commonly referred to as warp and weft directions) allow the fabric to better conform to the patient's body without introducing friction and adding to the support provided by the foam materials. A total coated fabric weight of 5 -15 oz per square yard provides a functional material for assembly.

The trapezoidal pad 4 is purposeful to reduce obstruction with other devices used in patient care. For example, the Special Medical Emergency Evacuation Device is used with military litters to hold equipment for patient care and mounts on the litter poles.

Build-up of skin moisture and wetness may complicate patient care. Wetness can be caused by rain, spilled fluids, sweat, bodily fluids, or through open wounds. A top cover material 16 that minimizes moisture accumulation can aid in patient care.

The support cushioning system may be used in harsh and rugged environments with rocky and uneven ground, and may be abraded if dragged along the ground, cut by sharp stones, or punctured by stones or sticks. The bottom cover material 15 is abrasion and tear resistant to protect the integrity of the pad when used on rough surfaces. A bottom cover material 15 capable of handling such an environment would reduce degradation and damage to the support surface and preserve the pressure injury reduction capabilities.

Furthermore, the cover materials 15, 16 are preferably waterproof to prevent intrusion of fluids into the underlying foam material as this may impact the performance of the foam. Otherwise, introduction of moisture into foam support materials would degrade pressure injury reduction performance. Additionally, the support surface foam materials would entrap the moisture resulting in a heavier system with reduced packability. Waterproof cover materials 15, 16 reduce the impact of a wet environment on the performance of the support surface.

This method of assembly of the cover 7 also provides functional properties to system. Fabric welding uses heat and pressure to join the top cover material 16 and bottom cover material 15. The cover material 15, 16 is also weldable to other fabrics as this produces a more consistent and stronger seam and prevents fluid intrusion. Strong welds between fabrics are achieved when fabrics, such as cover material 15, 16, are compatible with each other. One way of achieving welding compatibility is to use fabrics coated with similar materials. In the embodiment in FIG. 3, cover materials 15, 16 are coated with polyurethane to achieve a strong bond between the materials. Polyurethane coating weight of 1-3 oz per square yard provides sufficient material for proper weld adhesion. Alternately a tie-layer can be used to weld dissimilar cover fabrics together.

Importantly, vent assembly 13 allows air transfer across the cover while serving as a barrier to fluid transfer. Preferably, vent 13 penetrates the cover 7 and forms a passage covered by a mesh (to be described) that is coated with a hydrophobic coating configured to create a water-repellent barrier that allows air passage but prevents water transfer. The vent assembly 13 enables air pressure to equalize between the environment and the internal foam components. The absence of a vent assembly 13 could result in a change in the skin interface reducing properties of the support cushion should there be a sudden change in air pressure. Sudden changes in air pressure could arise from a change in altitude such as during helicopter or airplane ascent and descent.

The indicia 14 provide the user information on proper use and care of the support system.

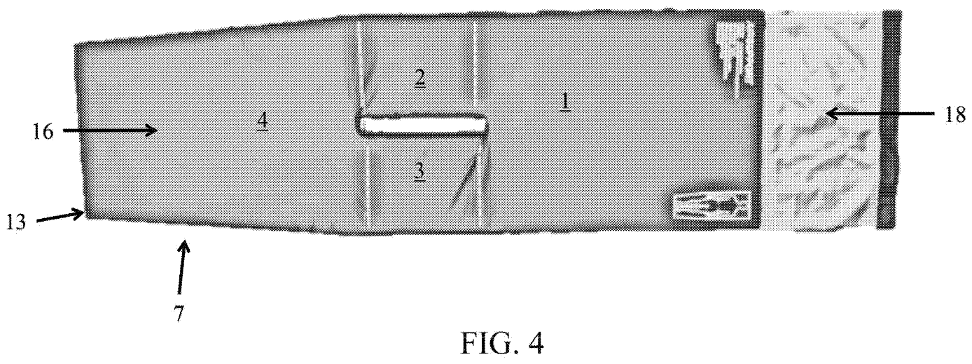

FIG. 4 shows a support cushion system with a fabric flap 18. This fabric flap 18 is used to assist in packing the support cushion system and holding the support cushion in the packed configuration. The fabric flap 18 may be permanently attached to the support cushion system. Alternately, the fabric flap 18 may be attached to the support cushion system using hook-and-loop, buttons, snaps, or similar mechanisms. The fabric flap 18 has additional hook-and-loop, buttons, snaps, or similar mechanisms properly placed to attach to itself when the support cushion system is packed and rolled. Additionally, the fabric flap may also include a pocket to store additional accessory items such as an inflatable pillow or inflatable bolster.

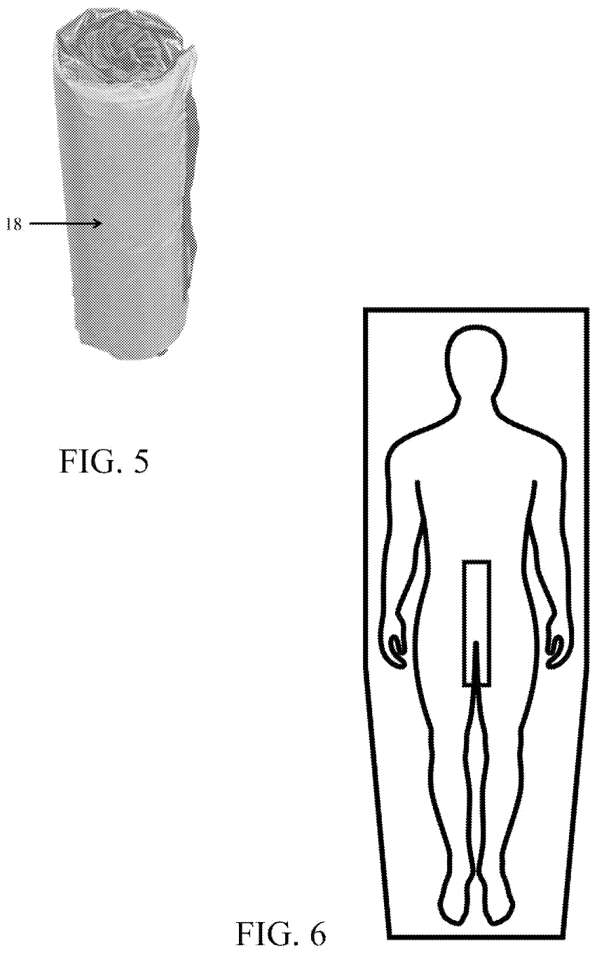

FIG. 5 shows the support cushion system compressed and rolled to reduce overall volume. Furthermore, the fabric flap 18 is rolled along with the support cushion and uses mechanisms to hold it in the rolled configuration.

FIG. 6 illustrates how the invention offloads the sacral region. The sacral region (sacrum) is at the bottom of the spine and lies between the fifth segment of the lumbar spine (L5) and the coccyx (tailbone). The sacrum is a triangular-shaped bone and consists of five segments (S1-S5) that are fused together. The present invention reduces compression of the sacral area by previously described combination of variable density and thicknesses of pads 1-4 as well as cutout 5. The sacral region is particularly susceptible to pressure related soft tissue injuries, particularly in the case of immobile patients. The soft tissue over the sacrum bone forms a bony prominence that carries the weight of the lower torso region. Incidence of injury increase further with moisture and fluid build-up at the sacrum region. Off-loading the sacrum region using a cutout 5 not only relieves pressure on the soft tissue, but also the area remains dry through fluid drainage and airflow. Increase in temperature further exacerbates pressure related injuries. Off-loading the sacral area enables air flow to cool the area.

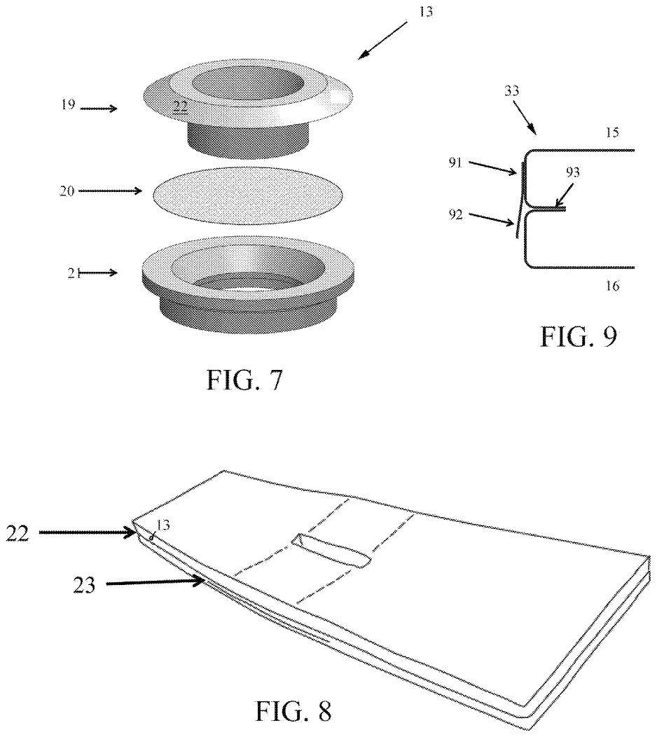

FIG. 7 shows the components of an embodiment of the vent assembly 13 used to equalize air pressure consisting of an exterior component 19, mesh 20, and interior component 21. The mesh 20 comprises a hydrophobic or oleophobic mesh that allows air to pass through and the coating on the mesh material repels water-based or oil-based fluids and prevents such fluids from passing through openings in the mesh. This can be achieved with a hydrophobic or oleophobic coating that repels fluids but allows air to pass. The overall shape of the vent assembly 13 serves to redirect flowing fluids around the vent opening. This is accomplished by a vent 13 formed as a grommet with an exterior component 19 formed in a ring with a beveled channel or lip 22, and an interior base 21 similarly formed in a ring with an exterior flange 27 that receives the exterior component.

The mesh 20 is sandwiched between exterior component 19 and interior component 21, the beveled lip 22 elevating the inlet to vent 13 which further minimizes fluid contact with the mesh 20. The shape of the vent also prevents direct contact of the mesh with the support materials in the cushion material. The vent assembly is preferably made from flexible components, e.g., plastic. This allows the vent to regain shape when the overall when the system is manipulated, such as when it is packed, or moved. Flexibility of the all vent 13 components also provides robustness from damage and loss of function due to impact in a rugged environment or from compression when the pad is packed. To assemble, the exterior component 19 faces away from the cushion and is placed over an appropriately sized hole in the cover material. The exterior component 19 has an opening that allows air passage. The mesh 20 is placed against the back of the outer piece 19 to create a recessed air passage. The interior component 21 mates with the exterior component 19 with the mesh and cover sandwiched between. The shape of inner piece 21 prevents direct contact of the mesh 20 with the cushioning material inside the cover. Adhesive is used to attach the vent assembly to the cover and to hold the vent assembly together. An alternate embodiment would use heat to weld the assembly to the cover material. The outer piece 19 and inner piece 21 are fabricated from flexible silicone or urethane materials.

The mesh 20 may be coated with any suitable hydrophobic or oleophobic coating that provides a barrier for a fluid pressure up to 0.1-1.0 psi. Such coatings typically comprise fluoropolymer or nanotechnology-based chemistries such as, for example, NanoSlic™, Aculon™, Superhydrophobic Nanoparticle Coatings (SNP), and Impermea Hydro-Tex 1000.

FIG. 8 shows the position of the vent assembly 13 on a vertical surface. In this position, the vent assembly 13 in FIG. 7 redirects fluid flow around or over the air passage to minimize direct fluid contact with the mesh 19.

FIG. 8 also shows the position of the seam 22 in the cover 7 and the filler slit 23 placed below the seam 22. The cover for the cushioning system is assembled separately where a seam 22 results from the joining of cover materials 15, 16. The seam 22 is preferably on the vertical sides of the cover to prevent direct contact of the seam 22 with the patient. A similar seam is present on the vertical sides of the cut-out region 5.

The vertical position of the seam 22 is placed mid-way between the top horizontal surface and the bottom horizontal surface. The position of the seam provides robustness to the design of system for patient care in rugged environments. A seam placed closer to the edge of the top surface could result in patient contact with the bottom cover material 15 which does not have the beneficial properties of the patient interfacing material 16. A seam placed closer to the edge of the bottom surface would expose the patient interfacing material 16 to contact with the ground or litter surface and could result in damage and loss of function of the cover 7.

The seam 22 is preferably a hidden seam such that the attachment of the top patient interfacing cover material 16 with the bottom cover material 15 is not visible or accessible from the exterior. For construction methods where the cover 7 is assembled by welding, this method places compatible surfaces of the top patient interfacing cover material 16 with the bottom cover material 15 for a bond without use of additional aides. A hidden seam configuration preserves the integrity of the seam from abrasion.

The filler slit 23 allows for assembly of a unified support surface in FIG. 5 inside the cover. Pads 1, 2, 3, 4 are individually assembled and the individual pads are positioned inside the cover accessed through the filler slit 23. Pads 1, 2, 3, 4 are then attached. Adhesives may be used to attach pads together. The filler opening slit 23 is then closed and sealed. The position of the filler opening slit is preferably on a surface not in contact with the patient. The filler slit 23 is preferably positioned in areas adjacent to foam attachment positions.

Assembly of the cushioning system using the filler slit 23 allows a hidden seam to be used to assemble the cover materials 15, 16 on the outer edge of the pad as well as inside the cut-out region 5. This approach provides for a simpler assembly method, direct access to mating surfaces of the pads, and minimizes the number and length of the filler slit 23.

FIG. 9 shows an alternate embodiment of a vent 33 that is integral to the seam 93 joining cover materials 15, 16. The cover materials 15, 16 are turned inward along seam 93 to create a hidden seam. One skilled in the art should understand that the cover materials 15, 16 may be turned outward to create an open seam. In both instances the seam 93 may be joined using heat-based welding or joined by sewn or stitching with thread. A vent 33 is formed by attaching a fabric flap 92 to cover material 15 by welding such that the fabric flap 92 overlaps the seam 93, but is not joined to cover material 16. Seam 93 is left open beneath the flap 92, e.g., not welded or stitched to provide a small passage. The fabric flap 92 allows air to escape but closes to obstruct water entry or other fluid penetration to the interior of the cover.

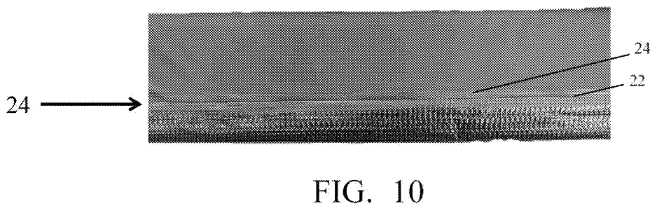

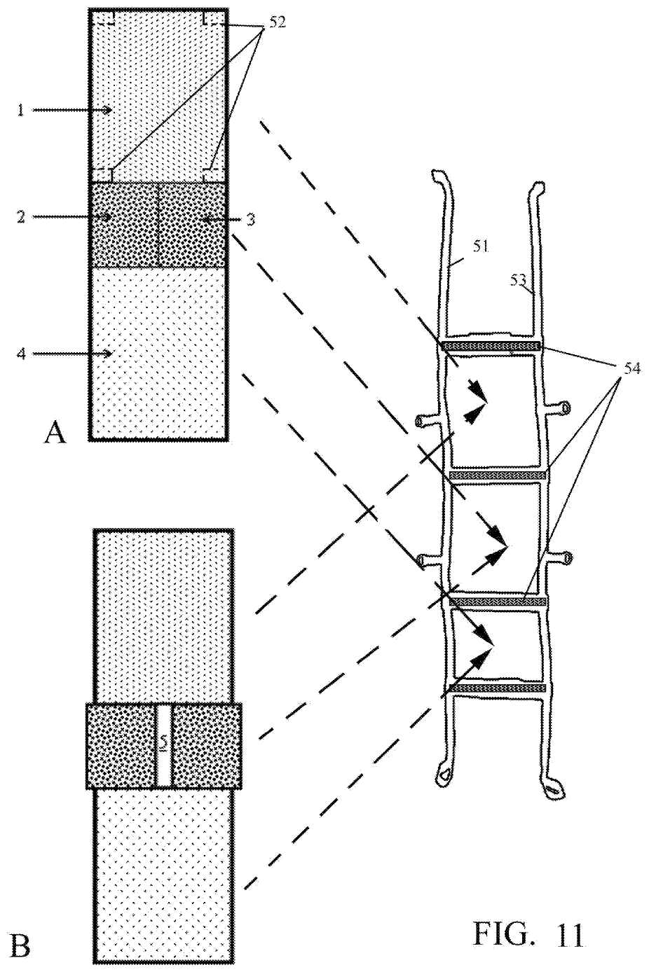

FIG. 10 shows a seam tape 24 applied over a seam 22 used to assemble the cover 7. Application of the tape is with heat in a manner similar to welding or with adhesive. The seam tape 24 is used to provide strength to a seam, improve visual quality, and reduce build-up of foreign matter in the seam 22. Foreign matter can degrade seam strength over time or can introduce pathogens that could complicate patient care.

In another embodiment shown in FIG. 11, the pads 1-4 are individually encapsulated by a vented and air-or water-sealed cover 7 as described above and are individually attachable to a harness system 50. Pads 1-4 are not directly attached to each other, yet may be attached at different positions as shown as at A and B to provide a reconfigurable array of pads 1-4. This way, when attached as per A the pads 1-4 are adjacent and there is no cut-out region 5, whereas at B pads 2-3 are slightly separated to provide a cut-out region 5. To accomplish this the pads 1-4 each include a plurality of strap fasteners 52 attached to the non-patient interfacing section of the cover 7, e.g., welded to each corner as at A. Each strap fastener 52 may be a hook or loop fastener (e.g., a Velcro fastener). In other embodiments strap fasteners 52 can be any other suitable fastener known in the art, such as, for example, snap fasteners. The harness 50 comprises a network of webbing that may be fabric, e.g., woven polyester or nylon, with pad connectors 54 arrayed along the webbing to allow the pads 1-4 to be attached yet repositionable there along. In the illustrated embodiment the harness 50 comprises a pair of spaced-vertical webbing members 51, 53 and a plurality of spaced horizontal webbing members 55, at least four, attached crosswise to the pair of spaced-vertical webbing members 51, 53 in a ladder-like configuration. Each pad connector 54 may be a mating strip of loop/hook fastener (e.g., a Velcro fastener) mounted across each horizontal webbing member 55, and optionally along each spaced-vertical webbing members 51, 53 between each horizontal webbing member 55. As an alternative to Velcro a spaced array of snap fasteners will suffice, or other suitable fasteners known in the art. The above provides an ability to reposition pads 1-4 and accommodates patients of varying body dimensions, such as varying height or arm length, and/or can accommodate for various sizes/positions of a bony protuberance. The vertical position of the horizontal webbing member 55 can be adjusted on the vertical webbing members 51, 53 using loops to allow the horizontal member to slide over the vertical webbing members.

Having now set forth the preferred embodiments and certain modifications of the concepts underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

1. A pressure injury relief system for recovery and transport of a patient, comprising:
a cushioning support comprising a plurality of adjacent attached polygonal padding blocks of varying density, said plurality of adjacent padding blocks being arranged in a side-by-side pattern to define a patient interfacing surface, an opposing support surface, and a cut-out region fully traversing through patient interfacing surface and opposing support surface of said cushioning support and surrounded by said padding blocks and configured to correspond to said patient's bony prominence when said patient lies on said cushioning support and eliminate contact with said bony prominence in the cut-out region;
a cover encapsulating all of said padding blocks and configured to maintain said padding blocks in said side-by-side pattern, said cover further comprising,
a patient interfacing section on one side welded to a non-interfacing section on an opposing side along a sidelong seam, the patent interfacing section further comprising a waterproof, non-breathable, stretchable fabric,
the non-patient interfacing section further comprising a waterproof, non-breathable tear-resistant fabric,
at least one vent penetrating said cover and forming a passage across the cover.

2. The pressure injury relief system according to claim 1 where the vent is a flap vent.

3. The pressure injury relief system according to claim 1 where the vent is covered by a mesh that is coated with a hydrophobic coating configured to create a water-repellent barrier to prevent water transfer.

4. The pressure injury relief system according to claim 2 where the vent is formed by a sewn seam and a flap of fabric overlapping the sewn seam to create a passage for air transfer and obstruction for water transfer.

5. The pressure injury relief system according to claim 1, wherein each padding block comprises one from among a group consisting of an open-cell foam pad and a thermoplastic polymer air fiber cushion.

6. The pressure injury relief system according to claim 1, wherein the at least one vent penetrating said cover further comprises a grommet having an exterior flange and interior base, said mesh being sandwiched between said flange and base for allowing air transfer yet preventing water transfer.

7. The pressure injury relief system according to claim 1, wherein the seam runs alongside said pressure injury relief system between the patient interfacing surface and opposing support surface of said cushioning support.

8. The pressure injury relief system according to claim 1, wherein the seam is a hidden waterproof seam.

9. The pressure injury relief system according to claim 1, wherein the patient interfacing side is any one of antimicrobial, electrically conductive, or elastic.

10. The pressure injury relief system according to claim 6, wherein the exterior flange of said vent comprises a plastic beveled ring, and the interior base of said vent comprises a plastic ring having a flange.

11. The pressure injury relief system according to claim 7, further comprising a filler slit that runs alongside said pressure injury relief system between the patient interfacing surface and opposing support surface of said cushioning support offset below the seam and configured for insertion of said padding blocks.

12. The pressure injury relief system according to claim 9, wherein the patient interfacing section of said cover is elastic with a stretch ratio within a range of 100-200% in both warp and weft directions.

13. The pressure injury relief system according to claim 1, further comprising any one from among a group including a lifting handhold, a lifting strap, and a strap for attachment to a patient movement device.

14. A pressure injury relief system for recovery and transport of a patient, comprising:
a plurality of adjacent attached polygonal padding blocks of varying density, said plurality of adjacent padding blocks including an upper rectangular padding block, a lower trapezoidal padding block, and a pair of middle padding blocks both comprised of a first layer of foam with a density ranging between 1.2-1.8 lbs/ft3 and a second layer of foam with a density ranging between 1.5-2.1 lbs/ft3, all of said padding blocks being arranged side-by-side in a hexagonal pattern to define a patient interfacing surface, an opposing support surface, and at least one cut-out region fully traversing through patient interfacing surface and opposing support surface of said cushioning support between said middle padding blocks and configured to correspond to said patient's bony prominence when said patient lies on said cushioning support and eliminate contact with said bony prominence in the cut-out region;
a cover encapsulating all of said padding blocks, said cover comprising a patient interfacing section welded to a non-interfacing section along a seam, the patent interfacing section further comprising a waterproof, non-breathable, stretchable fabric, and the non-patient interfacing side further comprising a waterproof, non-breathable tear-resistant fabric.

15. The pressure injury relief system according to claim 14, wherein each padding block comprises one from among a group consisting of an open-cell foam pad and a thermoplastic polymer air fiber cushion.

16. The pressure injury relief system according to claim 14, further comprising at least one vent penetrating said cover and configured to block water yet vent air.

17. The pressure injury relief system according to claim 16, wherein each of said at least one vent comprises a sewn seam and a flap of fabric overlapping the sewn seam to create a passage for air transfer and obstruction for water transfer.

18. The pressure injury relief system according to claim 16, wherein each of said at least one vent comprises a passage covered by a mesh that is coated with a hydrophobic coating configured to create a water-repellent barrier to prevent water transfer.

19. The pressure injury relief system according to claim 18, wherein each of said at least one vent comprises a grommet having an exterior flange, interior base, said mesh being sandwiched between said flange and base for allowing air transfer, said mesh being coated with said hydrophobic coating to create a water-repellent barrier and prevent water transfer.

20. The pressure injury relief system of claim 14, wherein the second layer of foam is within a range of from 2.33 to 1.86 times thicker than said first layer of foam.

21. The pressure injury relief system according to claim 14, wherein the seam is a hidden waterproof seam.

22. The pressure injury relief system according to claim 14, wherein the patient interfacing side is any one of antimicrobial, electrically conductive, or elastic.

23. The pressure injury relief system according to claim 14, further comprising a filler slit that runs alongside said pressure injury relief system between the patient interfacing surface and opposing support surface of said cushioning support offset below the seam and configured for insertion of said padding blocks.

24. The pressure injury relief system according to claim 14, further comprising a fabric flap configured to be rolled up along with the cushioning support to maintain a rolled configuration for stowage or storage.

25. The pressure injury relief system according to claim 14, further comprising any one from among a group including a lifting handhold, a lifting strap, and a strap for attachment to a patient movement device.

26. A pressure injury relief system for recovery and transport of a patient, comprising:
a harness system comprising a plurality of interconnecting webbing members and a plurality of attachment devices mounted along said interconnecting webbing members;
a plurality of polygonal padding blocks of varying density, each of said plurality of padding blocks including a cover encapsulating each of said plurality of padding blocks, each of said covers having a patient interfacing section welded to a non-interfacing section along a seam, the patent interfacing section further comprising a waterproof, non-breathable, stretchable fabric, the non-patient interfacing side further comprising a waterproof, non-breathable tear-resistant fabric.
